(19) United States
(12) Patent Application Publication
(10) Pub. No.: US 2006/0004677 A1
(43) Pub. Date: Jan. 5, 2006

(54) System for portable franking services

(76) Inventor: James M. Mattern, Bethany, CT (US)

Correspondence Address: PERMAN & GREEN, 425 POST ROAD, FAIRFIELD, CT, 06824, US

(21) Appl. No.: 11/047,291

(22) Filed: Jan. 31, 2005

Related U.S. Application Data
(60) Provisional application No. 60/584,435, filed on Jun. 30, 2004.
(60) Provisional application No. 60/588,424, filed on Jul. 16, 2004.
(60) Provisional application No. 60/588,425, filed on Jul. 16, 2004.

(51) Int. Cl. G06F 17/00

(52) U.S. Cl. 705/403

(57) ABSTRACT

A system for providing portable franking services includes one or more portable franking devices, a network, and a postage meter connected to the one or more portable franking devices through the network. The postage meter includes a communication port for detecting the portable franking device and for loading fund information into the portable franking device. The system may also include one or more postal infrastructure data centers, where the meter establishes a connection with one of the postal infrastructure data centers depending on the location of the meter.

This application claims the benefit of U.S. Provisional Application 60/584,435, filed Jun. 30, 2004, U.S. Provisional Application 60/588,424, filed Jul. 16, 2004, and U.S. Provisional Application 60/588,425, filed Jul. 16, 2004, which are incorporated by reference herein in their entirety.

### BACKGROUND

The disclosed embodiments relate to a multifunctional franking system that provides portable indicia services.

### BRIEF DESCRIPTION OF RELATED DEVELOPMENTS

A high volume postal customer may use a meter which incorporates a Postal Security Device (PSD) to secure the proof of payment of postal indicia. In an exemplary application, indicia may be applied to mailing items that identifies the value of the postage applied and other information. A customer may purchase postage and the purchased value may be stored in the PSD. As the postage indicia is applied to items, the value applied may be deducted from the stored value. Once postage indicia is applied, the item may then be dropped into the collection stream of the particular postal system and subsequently processed for delivery.

It would be advantageous to provide one or more portable franking devices that may communicate with a meter that in turn may communicate with a postal service infrastructure for providing a variety of indicia services.

### SUMMARY OF THE DISCLOSED EMBODIMENTS

A system for providing portable franking services includes one or more portable franking devices, a network, and a postage meter connected to the one or more portable franking devices through the network. The postage meter includes a communication port for detecting the portable franking device and for loading fund information into the portable franking device. The system may also include one or more postal infrastructure data centers, where the meter establishes a connection with one of the postal infrastructure data centers depending on the location of the meter. The one or more portable franking devices and the meter may include location determination circuitry and may provides location specific indicia based on their respective locations. The one or more portable franking devices and the meter may also provide location specific indicia based on a particular collection point.

### BRIEF DESCRIPTION OF THE DRAWINGS

The foregoing aspects and other features of the disclosed embodiments are explained in the following description, taken in connection with the accompanying drawings, wherein:

FIG. 1 shows a block diagram of a system suitable for practicing the disclosed embodiments;

FIG. 2 shows a block diagram of meter according to the disclosed embodiments;

FIG. 3 shows a diagram of a portable franking device according to the disclosed embodiments; and

FIG. 4 shows a diagram of a postage infrastructure data center.

### DETAILED DESCRIPTION OF THE PREFERRED EMBODIMENTS

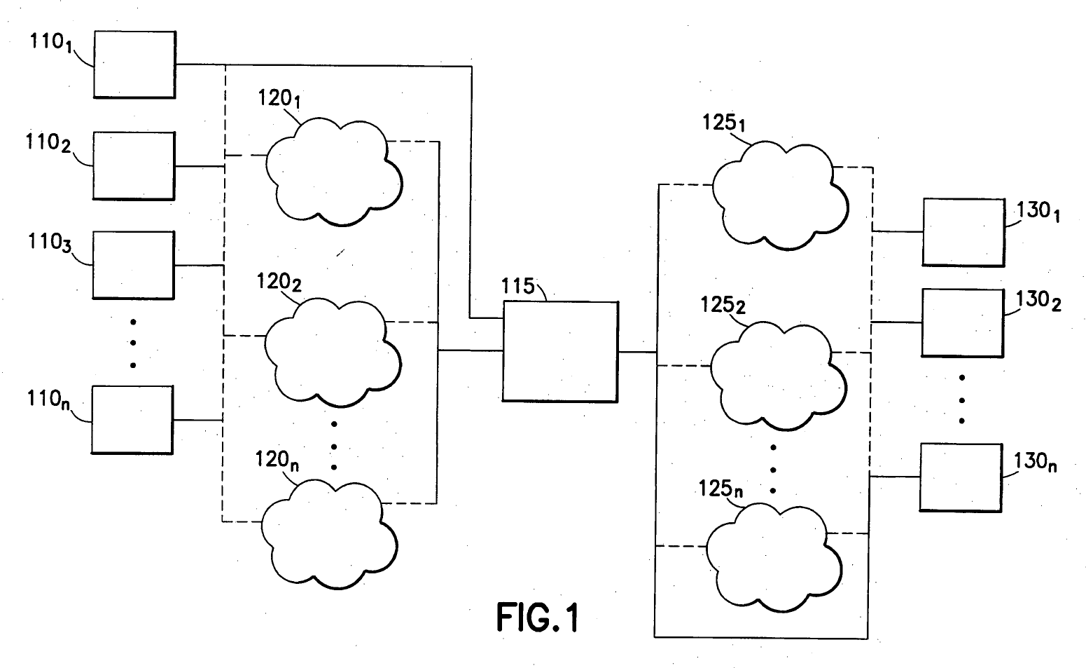

FIG. 1 shows a block diagram of a system 100 suitable for practicing the disclosed embodiments disclosed herein. Although the disclosed embodiments will be described with reference to the embodiment shown in the drawings, it should be understood that the disclosed embodiments can be embodied in many alternate forms of embodiments. In addition, any suitable size, shape or type of elements or materials could be used.

System 100 includes one or more portable franking devices 1101 . . . 110n and a funding device, shown in FIG. 1 as a meter 115, connected through one or more first networks 1201 . . . 120n. System 100 also includes one or more postal infrastructure data centers 130₁ . . . 130ₙ connected to the meter 115 through one or more second networks 125₁ . . . 125ₙ.

It is a feature of the disclosed embodiments to allow the one or more portable franking devices 110₁ . . . 110ₙ to access meter 115 for funding. Portable franking devices 110₁ . . . 110ₙ may provide any indicia that has value, for example, postage, tickets allowing admission to an event or allowing the use of a service, and the like.

In one embodiment individual portable franking devices 110₁ . . . 110ₙ may initiate communication with meter 115. In another embodiment, meter 115 may identify that one or more portable franking devices 110₁ . . . 110ₙ are capable of communicating with meter 115 and may initiate a connection.

In one embodiment, portable franking devices 110₁ . . . 110ₙ may connect to meter 115 wirelessly. In another embodiment, the connection may be a wired connection.

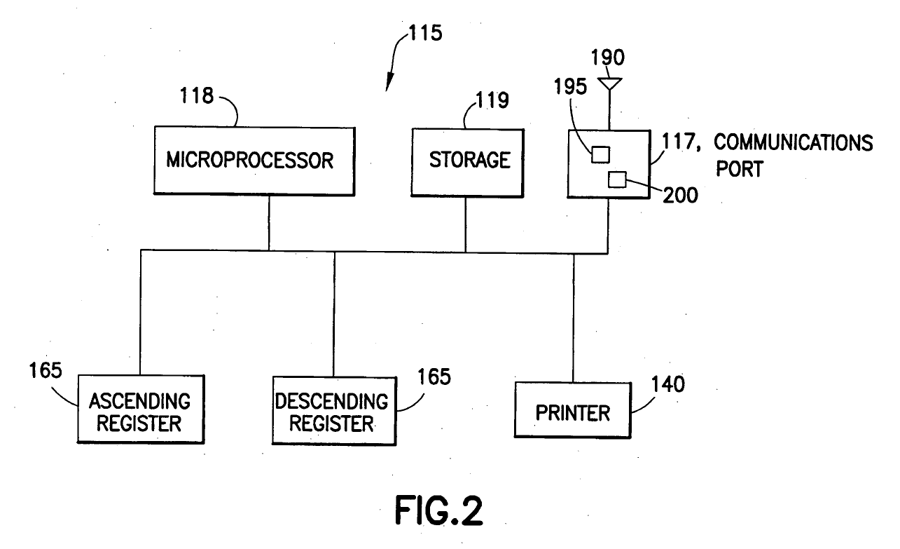

FIG. 2 shows a general block diagram of meter 115. Meter 115 may include a communications port 117 and a microprocessor 118 for performing electronic accounting functions, control functions, and franking functions according to programs stored in a storage device 119. Some of these functions or subsets of these functions may be grouped within a secure perimeter as what is commonly referred to as a Postal Security Device (PSD).

Storage device 119 generally stores machine readable program code which is adapted to cause microprocessor 118 to perform the functions of the disclosed embodiments. Storage device 119 may utilize optical, magnetic, semiconductor, electronic, or other types of suitable devices to store the program code.

Microprocessor 118 typically performs the electronic accounting functions in relation to franking items. Data associated with the accounting functions may include an accumulated total value of credit entered into the PSD, an accumulated total value of charges dispensed by the PSD by franking items, a count of the number of items franked, and a count of the number of items franked with a charge in excess of a predetermined value. The accumulated total value of credit may be stored in an ascending credit register 160, the accumulated total value of postage charges dispensed may be stored in a descending register 165, and the count of items may be stored in an items count register 170. The various registers may be located in storage device 119.

The franking functions performed by microprocessor 118 typically include providing portable franking devices 110₁ . . . 110ₙ with an indication, funds, or other authorization to produce indicia, and reporting the number of items, value marked and other parameters to the accounting functions. Such indication, funds, or other authorization are referred to herein as indicia services.

The meter 115 may also provide indicia services locally utilizing a printer 140 and may be capable of franking a label, directly franking a mail piece, or franking any other suitable substrate. Meter 115 is advantageous in that a user may place meter 115 in a specific location on or over a substrate and frank or print an object. Meter 115 may be capable of printing stamps, barcodes, addresses, planet codes, images, text, indicia, logos, graphics, or any other printable item in any desired order. For example, the user may be able to position meter 115 to print a return address, and then position meter 115 to print a mailing address, and then to print postage.

The printer 140 may be capable of printing on any suitable substrate or media, including an adhesive or tacky substrate, and may also be capable of applying a covering over the printed items. For example, the printer 140 may be capable of applying a film or coating over a printed item for protection or to prevent tampering.

The printer 140 may be an inkjet, dye sublimation, thermal wax, laser, electrostatic, xerographic, thermal, RF, or any suitable type of printer. In one embodiment, printer 140 may utilize energy beams, having high or low power, for example, RF beams, to print directly onto a substrate.

The control functions performed by microprocessor 118 may include utilizing communications port 117 to communicate with and provide indicia services to the one or more portable franking devices 110₁ . . . 110ₙ. Communications port 117 generally includes an antenna 190 and support circuitry 195 or other signaling devices 200 for communicating with the portable franking devices 110₁ . . .110ₙ. The signaling devices 200 may utilize first networks 120₁ . . . 120ₙ to provide an air interface, a wired interface, a wireless interface, or an electrical, electromagnetic, radio, infrared, or other suitable facility for communicating with portable franking devices 110₁ . . . 110ₙ. The support circuitry 195 may also include location determining circuitry, for example, a GPS facility for determining the location of the meter 115.

The control functions may further include utilizing communications port 117 for communication with the one or more postal infrastructure data centers 130₁ . . . 130ₙ through the one or more second communication networks 125₁ . . . 125ₙ. The antenna 190 and support circuitry 195, as well as the other signaling devices 200 may support such communication in a manner similar to the communication provided with portable franking devices 110₁ . . . 110ₙ through first networks 120₁ . . . 120ₙ, and may also provide a direct communication path to the one or more postal infrastructure data centers 130₁ . . . 130ₙ.

The provision of indicia services is performed by microprocessor 118 under the control of programs located in storage device 119.

The one or more of the portable franking devices 110₁ . . . 110ₙ may access the meter 115 by establishing a connection to the meter 115, either directly or through the one or more networks 120₁ . . . 120ₙ (FIG. 1).

As another feature of the disclosed embodiments, meter 115 may identify that one or more of the portable franking devices 110₁ . . . 110ₙ is capable of communicating with meter 115. For example, meter 115 may attempt to identify any portable franking device 110₁ . . . 110ₙ directly connected or connected to network 120, for example by polling network addresses or other identification techniques. Meter 115 may also attempt to identify portable franking devices by broadcasting a paging signal or other type of signal that requests a response. This signal may be broadcast to portable franking devices 110₁ . . . 110ₙ that are directly connected or broadcast through first networks 120₁ . . . 120ₙ (FIG. 1).

First networks 120₁ . . . 120ₙ may include any suitable communications network, for example, the Public Switched Telephone Network (PSTN), a wireless network, a wired network, a Local Area Network (LAN), a Wide Area Network (WAN), virtual private network (VPN), air interface, etc. The air interface may include any suitable wireless communication protocol or signaling techniques or standards, for example TDMA, CDMA, IEEE 802.11, Bluetooth, close range RF, optical, any appropriate satellite communication standards, etc.

After a connection has been established, one or more of the portable franking devices 110₁ . . . 110ₙ may utilize meter 115 for indicia services. These functions and selections may include purchasing postage, purchasing admission to one or more events, purchasing merchandise or services, or otherwise producing indicia that has value.

In addition, indicia services may also include providing accounting functions for the portable franking devices 110₁ . . . 110ₙ individually or as groups of portable franking devices, which may include reporting funds that have been expended or that are remaining, categorizing funds that have been expended using predefined criteria, etc. For example, each portable franking device or group of devices may be assigned an account where accounting and reporting functions may be keyed to the account.

As another feature of the disclosed embodiments, meter 115 may have the capability to access one or more of the postal infrastructure data centers 130₁ . . . 130ₙ to download updates or additional service capability as desired. For example, meter 115 may access one or more of the postal infrastructure data centers 130₁ . . . 130ₙ to provide delivery confirmation for specific mail pieces.

Referring to FIG. 3, a portable franking device 110 may generally include a microprocessor 300, on-board memory 310, an analog to digital converter 315, a real time clock interrupt controller 320, a power source 325, for example, a battery, and communication circuitry 330. Communication circuitry 330 may include an antenna 345 and other circuitry and devices 340 for wireless communication with meter 115. In other embodiments, devices 340 may include suitable circuitry, programs, transmitters and receivers for any appropriate type of wireless communication utilizing radio frequency (RF), infrared (IR), optical, acoustical, any type of electromagnetic based technology, or any other type of wireless communication. The devices 340 may also include location determining circuitry, for example a GPS facility, for determining the location of the portable franking device 110.

The microprocessor 300 may operate under the control of programs found in the on board memory 310. The on board memory 310 may provide storage information associated with the operation of the portable franking device. The on board memory 310 may be configured as a non-volatile memory which retains its contents in the event of a power loss.

The portable franking device 110 generally includes a user interface 335 which may include a keyboard, display, touch screen, etc.

In one embodiment, portable franking device 110 may be a portable digital assistant (PDA). In other embodiments portable franking device 110 may be a laptop or notebook computer, an MP3 player, a mobile telephone, a pager, a portable communications device, a portable appliance, or any device having suitable facilities for computing, communication, and applying indicia.

Fund information may be loaded and transactions may be reported each time a franking operation is to occur. Each time a user initiates a franking operation, the portable franking device 110 may attempt to connect to meter 115, download fund information for the operation, and then report the transaction.

In another embodiment, the portable franking device 110 may always be connected to the meter 115, and may initiate a request for additional funds and report the transaction.

In still another embodiment, fund downloading and reporting may be exchanged in batch, that is, upon reaching a threshold or satisfying a particular criteria, the portable franking device 110 may connect to the remote device and exchange funds and reporting data.

In yet another embodiment, fund downloading and reporting may be accomplished using a polling routine. In one example, polling may be initiated by the meter 115, where upon request, the portable franking device 110 begins an information exchange.

The type of fund information may include postage, tickets, credit, or any representation of value. The information may include fund information for a specific amount of a particular type, for example, the device may always download $50.00 of postage upon reaching a threshold. Other fund information configurations may include a download that includes funds distributed over a number of types, for example, $30.00 of postage, $40.00 of tickets to an event, and $100.00 of rental car credits.

In a further embodiment, the fund information provided may be limited to an amount required for a particular time period or to an amount determined using a loss calculation, that is, a an amount that the provider can afford to lose before detection.

Like the meter 115, the portable franking device 110 may include a printer 350 and may be capable of franking a label, directly franking a mail piece, or franking any other suitable substrate. The portable franking device 110 may be placed in a specific location on or over the substrate and may frank or print an object. The portable franking device 110 may be capable of printing stamps, barcodes, addresses, planet codes, images, text, indicia, logos, graphics, or any other printable item in any desired order. For example, similar to the meter 115, a user may be able to position the portable franking device 110 to print a return address, and then position the portable franking device 110 to print a mailing address, and then to print postage.

The printer 350 may be similar to printer 140 (FIG. 2) in that it may be capable of printing on any suitable substrate or media, including an adhesive or tacky substrate, and may also be capable of applying a covering over the printed items. As another example, the printer 350 may be capable of applying a film or coating over a printed item for protection or to prevent tampering.

The printer 350 may be an inkjet, dye sublimation, thermal wax, laser, electrostatic, xerographic, thermal, RF, or any suitable type of printer. In one embodiment, printer 350 may utilize energy beams, having high or low power, for example, RF beams, to print directly onto a substrate.

Returning to FIG. 1, as yet another feature of the disclosed embodiments, meter 115 may optionally be portable and may initiate communication with the one or more postal infrastructure data centers 130₁ . . . 130ₙ that may be available while meter 115 is mobile. The one or more postal infrastructure data centers 130₁ . . . 130ₙ generally provide postal infrastructure services, for example, funds replenishment, data table updates, additional or updated features, data collection from meter 115, and other types of data communication with meter 115. Such data communication is referred to herein as a data exchange.

The availability of one or more of the postal infrastructure data centers 130₁ . . . 130ₙ may depend on the relative geographical location of the meter 115 with respect to the one or more postal infrastructure data centers 130₁ . . . 130ₙ.

In one embodiment, communication between meter 115 and the one or more postal infrastructure data centers 130₁ . . . 130ₙ may be wireless. In other embodiments, the communication may occur through a combination of wireless and wired connections, or only wired connections.

Meter 115 initiates a data exchange by initially detecting one or more second communications networks 125₁ . . . 125ₙ suitable for the data exchange. Meter 115 may logon or establish a connection to a particular second communications network 125 by addressing a message specifically to that communications network. Alternately, meter 115 may identify that one or more second communications networks 125₁ . . . 125ₙ are available for providing communications and may perform a selection process among the available second communications networks 125₁ . . . 125ₙ. For example, meter 115 may broadcast polling or paging signals in attempt to receive a response from a second communication network. In the event that more than one second communication network responds, meter 115 may select a responding second network based on any combination of signal strength, quality of service, connection speed, cost, etc.

Second communication networks 125₁ . . . 125ₙ may include any suitable communications network, for example, the Public Switched Telephone Network (PSTN), a wireless network, a wired network, a Local Area Network (LAN), a Wide Area Network (WAN), virtual private network (VPN), an air interface, etc. The air interface may include any suitable wireless communication protocols or signaling techniques or standards, for example TDMA, CDMA, IEEE 802.11, Bluetooth, close range RF, optical, any appropriate satellite communication standards, etc. In one embodiment, one or more of the first communication networks 120₁ . . . 120ₙ may be the same as one or more of the second communication networks 125₁ . . . 125ₙ.

In one embodiment, meter 115 may utilize cell communication technology and identify a cellular communication network from the one or more second networks 125₁ . . . 125ₙ using roaming techniques.

After meter 115 has established a connection with an appropriate second communication network 125, meter 115 then attempts to logon or establish a connection to one or more data centers 130₁ . . . 130ₙ. Meter 115 may attempt to connect to an individual data center 130 by addressing a message specifically to that data center 130. Alternately, meter 115 may identify that one or more data centers 130₁ . . . 130ₙ are available for providing services to meter 115. For example, meter 115 may attempt to identify any data centers 130₁ . . . 130ₙ directly connected to meter 115 or connected to second networks 125₁ . . . 125ₙ, for example by polling network addresses or other identification techniques. Meter 115 may also attempt to identify data centers 130₁ . . . 130ₙ by broadcasting a paging signal or other type of signal that requests a response. This signal may be broadcast to data centers 130₁ . . . 130ₙ that are connected to second networks 125₁ . . . 125ₙ, including those that may be connected through an appropriate air interface.

In an embodiment using cell communication technology, meter 115 may place a call to one or more data centers 130₁ . . . 130ₙ.

Meter 115 may be capable of establishing more that one connection to a particular data center 130 and may be capable of establishing a connection to more than one data center 130₁ . . . 130ₙ simultaneously. For example, meter 115 may establish a first connection to a first data center 130₁ for fund replenishment and, during the first connection, may establish a second connection to the first data center 130₁ to download data tables. As another example, meter 115 may establish a first connection to a first data center 130₁ for fund replenishment and, during the first connection, may establish a second connection to a second data center 130₂ to download data tables.

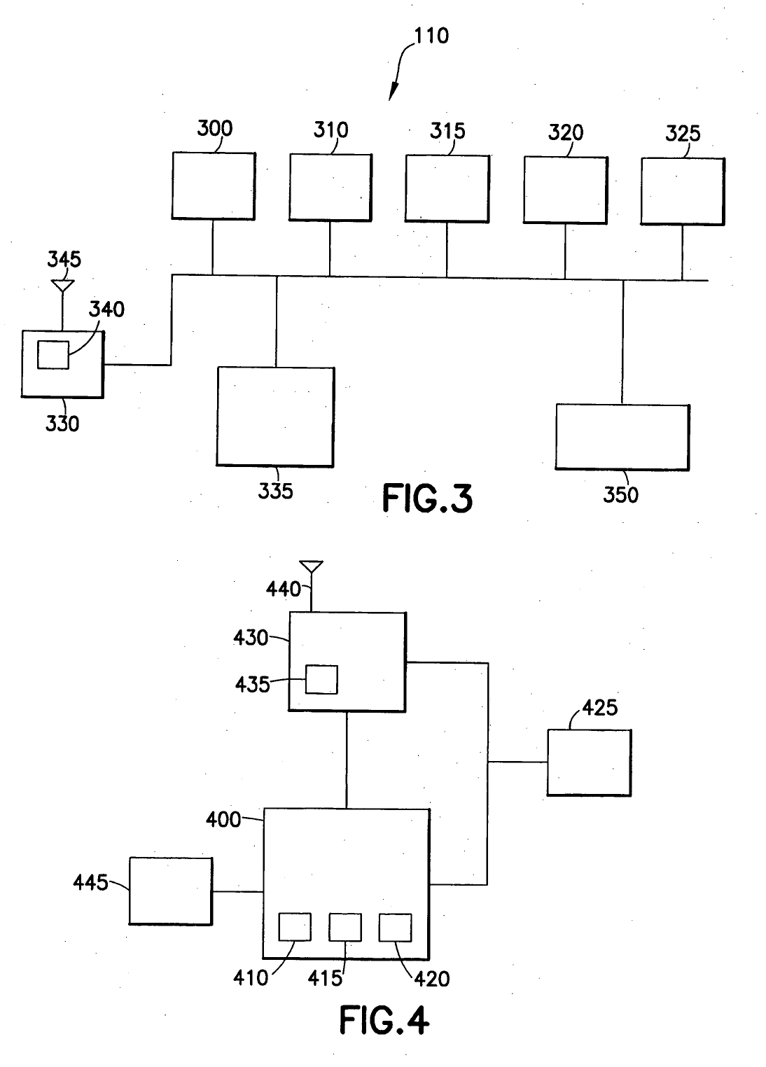

Referring to FIG. 4, a postal infrastructure data center 130 may generally include a server 400, several data bases 410, 415, 420, a power facility 425, for example, a power distribution network, and communication circuitry 430. Communication circuitry 430 may include an antenna 440 and other circuitry and devices 435 for communication with meter 115 through the one or more second networks 125₁ . . . 125ₙ and directly with meter 115.

In other embodiments, devices 435 may include suitable circuitry, programs, transmitters and receivers for any appropriate type of wireless communication utilizing radio frequency (RF), infrared (IR), optical, acoustical, any type of electromagnetic based technology, or any other type of wireless communication. The postal infrastructure data center 130 may also include a user interface facility 445 which may provide local users with access to postal infrastructure data center services.

Each time a user initiates a franking operation through meter 115 or through portable franking device 110 (FIG. 1) meter 115 may attempt to connect to the one or more postal infrastructure data centers 130₁ . . . 130ₙ to download fund information or for other data exchange operations, and then report the transaction.

In another embodiment, meter 115 may always be connected to the one or more postal infrastructure data centers 130₁ . . . 130ₙ, and may initiate a request for additional funds, generate a report for each transaction, and otherwise exchange data.

In still another embodiment, fund downloading, reporting, and other data may be exchanged in batch, that is, upon reaching a threshold or satisfying a particular criteria, meter 115 may connect to the one or more postal infrastructure data centers 130₁ . . . 130ₙ and exchange funds and data.

As another feature of the disclosed embodiments, meter 115 may print indicia specific to its location, or specific to a location from which a mail piece is to be placed into a postal service collection point.

In this aspect of the disclosed embodiments, when indicia services are required by the one or more portable franking devices 110₁ . . . 110ₙ, or by the meter 115, the meter 115 may initiate communication with at least one of the postal infrastructure data centers 130₁ . . . 130ₙ that may be available. As part of this feature, the at least one postal infrastructure data center 130 provides location information for use when printing the indicia as part of the data exchange.

The availability of one or more of the postal infrastructure data centers 130₁ . . . 130ₙ may depend on the relative geographical location of one or more portable franking devices. 110₁ . . . 110ₙ or the meter 115, with respect to the one or more postal infrastructure data centers 130₁ . . . 130ₙ

According to the disclosed embodiments, when a user initiates a franking operation through at least one of the portable franking devices 110₁ . . . 110ₙ or through the meter. 115, the meter 115 may attempt to connect to at least one postal infrastructure data center 130 to receive location information to be incorporated into the indicia.

For example, a user in the vicinity of a postal service collection point operates a portable franking device 110 or meter 115 to apply indicia to a mail piece for deposit at the collection point. Connections are established among the portable franking device 110, meter 115, and postal infrastructure data center 130 using any of the methods described above. The postal infrastructure data center 130 determines the location of portable franking device 110 or the meter 115 using any suitable technique, including posing a question to the user, triangulation, relative signal strength, location within one of the first or second networks, etc.

In some embodiments, postal infrastructure data center 130 may determine the location of the portable franking device 110 using the GPS capability of the devices 340 (FIG. 3). Postal infrastructure data center 130 may determine the location of the meter 115 using the GPS capabilities of support circuitry 195 (FIG. 2).

Once the location of the device requesting indicia, portable franking device 110 or meter 115, has been determined, data center 130 may determine which post office or postal system services that location, and may provide appropriate location information to the portable franking device 110 or the meter 115 for incorporation into the indicia. Data center 130 may also provide billing capabilities and debit the user's account for the indicia cost, while correspondingly crediting the post office or postal system.

In another embodiment, meter 115 may periodically poll data center 130 and download related location information to be included with indicia. In this manner, portable franking device 110 or meter 115 may print indicia without waiting for a connection to data center 130.

In yet another embodiment, portable franking device 110 or meter 115 may provide indicia for a mail piece that is to be deposited in another location. For example, a user may desire to frank a mail piece while traveling and then deposit it at a collection point upon arrival at a destination. In this embodiment, a user may specify a particular location when requesting indicia through portable franking device 110 or meter 115, meter 115 may connect to data center 130 and request indicia information for the particular location. Alternately, data center 130 may provide meter 115 with a list of locations from which to choose. Meter 115 may then download the list to the portable franking device 110 for display or display the list on its user interface as appropriate.

It should be understood that the foregoing description is only illustrative of the disclosed embodiments. Various alternatives and modifications can be devised by those skilled in the art without departing from the disclosed embodiments. Accordingly, the disclosed embodiments is intended to embrace all such alternatives, modifications and variances which fall within the scope of the appended claims.

What is claimed is:

1. A system for providing portable franking services comprising:
a portable franking device;
a network; and
a postage meter connected to the portable franking device through the network, the postage meter including a communication port for detecting the portable franking device and for loading fund information into the portable franking device.

2. The system of claim 1, further comprising a plurality of postal infrastructure data centers, wherein the meter establishes a connection with one or more of the plurality of postal infrastructure data centers depending on the location of the meter.

3. The system of claim 1, wherein the portable franking device includes location determination circuitry and provides location specific indicia based on a location of the portable franking device.

4. The system of claim 1, wherein the meter includes location determination circuitry and provides location specific indicia based on a location of the meter.

5. The system of claim 1, wherein the portable franking device provides location specific indicia based on a particular mail piece collection point.

6. The system of claim 1, wherein the meter provides location specific indicia based on a particular mail piece collection point.

7. The system of claim 1, wherein the portable franking device includes circuitry for providing any indicia that has value.

8. The system of claim 1, wherein the portable franking device includes circuitry for initiating communication with the postage meter each time the portable franking device performs a franking operation.

9. The system of claim 1 wherein the portable franking device includes circuitry for maintaining constant communication with the postage meter for downloading fund information.

10. The system of claim 1, wherein the portable franking device includes circuitry for initiating communication with the postage meter for downloading fund information upon the satisfaction of a particular criteria.

11. The system of claim 1, wherein the postage meter includes circuitry for initiating communication with the portable franking device.

12. The system of claim 1, wherein the postage meter provides the portable franking device with authorization to produce indicia.

13. The system of claim 1, wherein the postage meter provides accounting functions for the portable franking device.

14. The system of claim 13, wherein the accounting functions include reporting expended and remaining funds, and categorizing the expended funds.

15. The system of claim 1, wherein the fund information includes an amount required for a particular time period.

16. The system of claim 1, wherein the fund information includes an amount determined using a loss calculation.

17. The system of claim 1, wherein the postage meter includes circuitry for providing indicia services directly.

18. The system of claim 2, wherein the one or more postal infrastructure data centers provide funds replenishment, data table updates, additional or updated features, and data collection for the meter.

19. The system of claim 2, wherein the meter initiates a data exchange with the one or more of the plurality of postal infrastructure data centers by detecting and selecting one or more communication networks through which to communicate with the one or more of the plurality of postal infrastructure data centers.

20. The system of claim 19, wherein the meter selects the one or more communication networks based on a combination of signal strength, quality of service, connection speed, and cost.

21. The system of claim 2, wherein the meter initiates a data exchange with the one or more of the plurality of postal infrastructure data centers by identifying that one or more of the data centers are available for providing services to the meter.

22. The system of claim 2, wherein the meter initiates a data exchange simultaneously with more than one of the plurality of postal infrastructure data centers.

23. The system of claim 2, wherein the meter initiates communication with the one or more data centers for a data exchange each time a franking operation is performed.

24. The system of claim 2, wherein the meter maintains constant communication with the one or more data centers for exchanging data.

25. The system of claim 2, wherein the meter initiates communication with the one or more data centers for a data exchange upon satisfying a particular criteria.

26. A method for providing portable franking services comprising:
using a postage meter to detect a portable franking device; and
loading fund information from the postage meter to the portable franking device upon detection.

27. The method of claim 26, further comprising establishing a connection among the meter and one or more of a plurality of postal infrastructure data centers depending on the location of the meter.

28. The method of claim 26, further comprising providing location specific indicia based on a location of the portable franking device.

29. The method of claim 26, further comprising providing location specific indicia based on a location of the meter.

30. The method of claim 26, further comprising providing location specific indicia based on a particular mail piece collection point.

31. The method of claim 26, further comprising initiating communication between the postage meter and the portable franking device each time the portable franking device performs a franking operation.

32. The method of claim 26, further comprising maintaining constant communication between the postage meter and the portable franking device.

33. The method of claim 26, further comprising initiating communication between the postage meter and the portable franking device upon satisfying a particular criteria.

34. The method of claim 26, further comprising providing the portable franking device with authorization to produce indicia.

35. The method of claim 26, further comprising providing accounting functions for the portable franking device.

36. The method of claim 35, wherein the accounting functions include reporting expended and remaining funds, and categorizing the expended funds.

37. The method of claim 27, further comprising providing funds replenishment, data table updates, additional or updated features, and data collection for the meter utilizing the one or more postal infrastructure data centers.

38. The system of claim 27, wherein the meter initiates a data exchange with the one or more of the plurality of postal infrastructure data centers by detecting and selecting one or more communication networks through which to communicate with the one or more of the plurality of postal infrastructure data centers.

39. The system of claim 38, wherein the meter selects the one or more communication networks based on a combination of signal strength, quality of service, connection speed, and cost.

40. The system of claim 27, wherein the meter initiates a data exchange with the one or more of the plurality of postal infrastructure data centers by identifying that one or more of the data centers are available for providing services to the meter.

41. The system of claim 27, wherein the meter initiates a data exchange simultaneously with more than one of the plurality of postal infrastructure data centers.

42. The system of claim 27, wherein the meter initiates communication with the one or more data centers for a data exchange each time a franking operation is performed.

43. The system of claim 27, wherein the meter maintains constant communication with the one or more data centers for exchanging data.
